(19) United States
(12) Patent Application Publication
(10) Pub. No.: US 2016/0148457 A1
(43) Pub. Date: May 26, 2016

(54) CARD READER ASSEMBLY

(71) Applicant: Yenfray Carrillo, Homestead, FL (US)

(72) Inventor: Yenfray Carrillo, Homestead, FL (US)

(21) Appl. No.: 14/551,316

(22) Filed: Nov. 24, 2014

(51) Int. Cl. G07F 7/10; G07F 7/08

(52) U.S. Cl. CPC G07F 7/1033; G07F 7/0873

(57) ABSTRACT

A card reader assembly includes a housing structured to have a card reader to read data on a card. A processor is coupled to the housing. The processor is electrically coupled to the card reader to receive the data on the card. A keypad is coupled to the housing. The keypad is structured to have Braille characters thereon to be used by a visually impaired user. The keypad is electrically coupled to the processor to enter a code, authorizing a transaction related to the card. A headphone jack is coupled to the housing. The headphone jack is electrically coupled to the processor to audibly alert the visually impaired user to the code entered into the keypad.

### BACKGROUND OF THE DISCLOSURE

### Field of the Disclosure

The disclosure relates to reader devices and more particularly pertains to a new reader device for allowing a visually impaired user to use a credit card or debit card.

### SUMMARY OF THE DISCLOSURE

An embodiment of the disclosure meets the needs presented above by generally comprising a housing structured to have a card reader to read data on a card. A processor is coupled to the housing. The processor is electrically coupled to the card reader to receive the data on the card. A keypad is coupled to the housing. The keypad is structured to have Braille characters thereon to be used by a visually impaired user. The keypad is electrically coupled to the processor to enter a code, authorizing a transaction related to the card. A headphone jack is coupled to the housing. The headphone jack is electrically coupled to the processor to audibly alert the visually impaired user to the code entered into the keypad.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a card reader assembly according to an embodiment of the disclosure.

FIG. 2 is a left side view of an embodiment of the disclosure.

FIG. 3 is a top view of an embodiment of the disclosure.

FIG. 4 is a front view of an embodiment of the disclosure.

FIG. 5 is a schematic view of an embodiment of the disclosure.

### DESCRIPTION OF THE PREFERRED EMBODIMENT

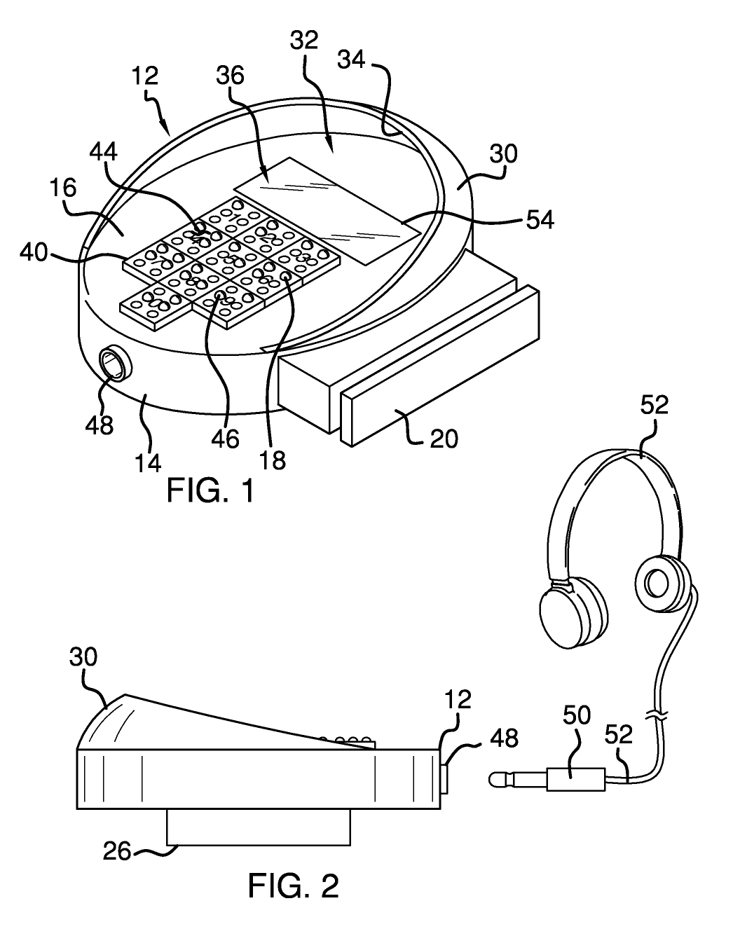

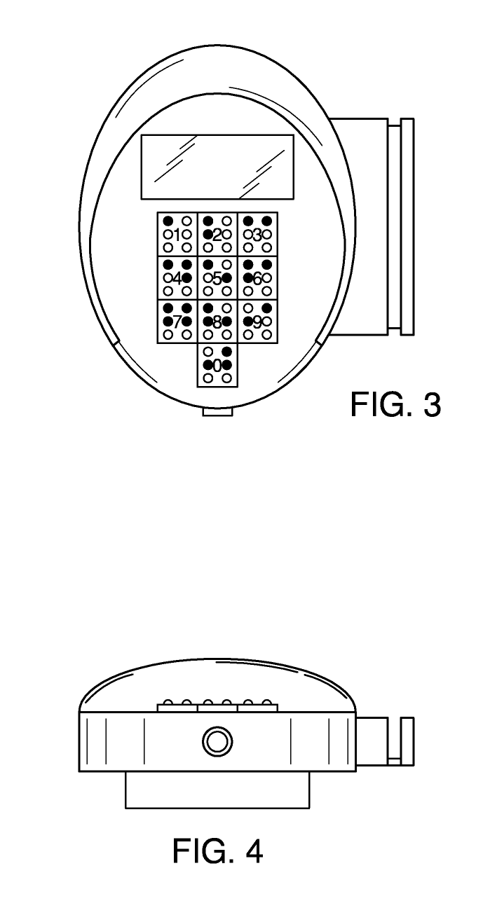

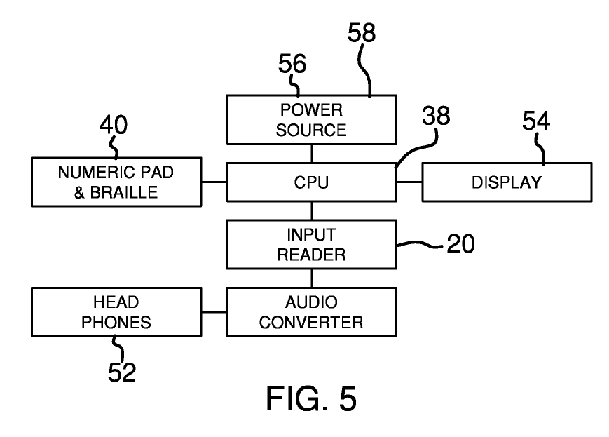

With reference now to the drawings, and in particular to FIGS. 1 through 5 thereof, a new reader device embodying the principles and concepts of an embodiment of the disclosure and generally designated by the reference numeral 10 will be described.

As best illustrated in FIGS. 1 through 5, the card reader assembly 10 generally comprises a housing 12. The housing 12 has an outer wall 14 extending between each of a top wall 16 and a bottom wall 18 of the housing 12. The outer wall 14 of the housing 12 may be curved so the housing 12 has an ovoid shape. The housing 12 is structured to define a card reader 20 extending outwardly from a first lateral side 22 of the outer wall 14. The card reader 20 may read data on a card 24. The card reader 20 may be an electromagnetic card reader or the like. The card 24 may be a credit card, a debit card or the like.

A bracket 26 is coupled to the bottom wall 18 of the housing 12. The bracket 26 may be coupled to a support surface 28. The support surface 28 may a counter or the like. The bracket 26 retains the housing 12 at a position that is accessible to a user.

A lip 30 is coupled to and extends upwardly from the top wall 16 of the housing 12. The lip 30 is positioned adjacent to the outer wall 14 such that the lip 30 surrounds an upper section 32 of the top wall 16. The lip 30 is curved such that a top edge 34 of the lip is directed inwardly toward a center 36 of the top wall 16. The top edge 34 of the lip 30 tapers downwardly toward the top wall 16 at each end of the lip 30.

A processor 38 is coupled to the housing 12. The processor 38 is electrically coupled to the card reader 20 to receive the data on the card 24. A keypad 40 is provided. The keypad 40 is coupled to the top wall 16 of the housing 12 so the keypad 40 is surrounded by the lip 30. The lip 30 conceals the keypad 40 from an observer viewing the housing from the outer wall of the housing. The keypad 40 is visible to the observer at a steep angle with respect to the top wall 16 of the housing 12.

The keypad 40 comprises a plurality of keys 42. A top surface 44 of each of the keys 42 has an alpha-numeric character thereon. Each key includes Braille characters corresponding to the alpha-numeric characters, facilitating usage by a visually impaired user 47. Each of the unique Braille characters 46 may be related to numerals ranging between 0 and 9. The keypad 40 is electrically coupled to the processor 38 to enter a code to authorize a transaction related to the card 24.

A headphone jack 48 is provided. The headphone jack 48 is coupled to the outer wall 14 of the housing 12. The headphone jack 48 is electrically coupled to the processor 38. The headphone jack 48 may insertably receive a plug 50 on a pair of headphones 52. The headphones 52 are electrically coupled to the processor 38 to audibly alert the visually impaired user 47 to the code entered into the keypad 40.

A display 54 is coupled to the top wall 16 of the housing 12 such that the display 54 is surrounded by the lip 30. The display 54 is electrically coupled to the processor 38 to display the data on the card 24. The display 54 may be an LCD display or the like.

A power supply 56 is coupled to the housing 12. The power supply 56 is electrically coupled to the processor 38. The power supply 56 comprises at least one battery 58.

In use, the visually impaired user 47 plugs the headphones 52 the headphone jack 48. The visually impaired user 47 swipes the card 24 through the card reader 22. The visually impaired user 47 enters a pin with the keypad 40. The headphones 52 provide the visually impaired user 47 with audible verification of each number entered with the keypad 40. The assembly 10 allows the visually impaired user to confidently utilize a credit card or debit card.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A card reader assembly comprising:
a housing structured to have a card reader wherein said card reader is configured to read data on a card, said housing having an outer wall extending between each of a top wall and a bottom wall of said housing;
a processor mounted in said housing, said processor being electrically coupled to said card reader wherein said processor receives the data on the card;
a keypad coupled to said housing, said keypad including a plurality of keys, each of said keys having an alpha-numeric character thereon, each key including Braille characters corresponding to said alpha-numeric characters to facilitate usage by a visually impaired user, said keypad being electrically coupled to said processor wherein said keypad is configured to enter a code to authorize a transaction related to the card;
a display coupled to said top wall of said housing said display being electrically coupled to said processor wherein said display displays the data on the card, said keypad being positioned adjacent to said display; and
a lip coupled to said housing such that said lip conceals said keypad from an observer, said lip being coupled to and extending upwardly from said top wall of said housing, said lip being positioned adjacent to an outer wall of said housing such that said lip surrounds an upper section of said top wall, said lip being curved such that a top edge of said lip is directed inwardly toward a center of said top wall such that said keypad and said display are both surrounded by said lip.

2. The assembly according to claim 1, further comprising said card reader being coupled to and extending outwardly from a first lateral side of said outer wall.

3. (canceled)

4. (canceled)

5. (canceled)

6. The assembly according to claim 1, further comprising a headphone jack coupled to said outer wall of said housing, said headphone jack being electrically coupled to said processor wherein said headphone jack is configured to audibly alert the visually impaired user to the code entered into said keypad.

7. The assembly according to claim 1, further comprising a power supply coupled to said housing, said power supply being electrically coupled to said processor, said power supply comprising at least one battery.

8. A card reader assembly comprising:
a housing, said housing having an outer wall extending between each of a top wall and a bottom wall of said housing, said housing being structured to define a card reader coupled to and extending outwardly from a first lateral side of said outer wall wherein said card reader is configured to read data on a card;
a lip coupled to and extending upwardly from said top wall of said housing, said lip being positioned adjacent to said outer wall such that said lip surrounds an upper section of said top wall;
a processor coupled to said housing, said processor being electrically coupled to said card reader wherein said processor receives the data on the card;
a keypad coupled to said top wall of said housing wherein said keypad is surrounded by said lip, said keypad including a plurality of keys, each of said keys having an alpha-numeric character thereon, each key including Braille characters corresponding to said alpha-numeric characters to facilitate usage by a visually impaired user, said keypad being electrically coupled to said processor wherein said keypad is configured to enter a code to authorize a transaction related to the card;
a headphone jack coupled to said housing, said headphone jack being electrically coupled to said processor wherein said headphone jack is configured to audibly alert the visually impaired user to the code entered into said keypad;
a display coupled to said top wall of said housing adjacent to said keypad, said display being electrically coupled to said processor wherein said display displays the data on the card; and
a power supply coupled to said housing, said power supply being electrically coupled to said processor, said power supply comprising at least one battery; and
said lip being curved such that a top edge of said lip is directed inwardly toward a center of said top wall such that said keypad and said display are both surrounded by said lip.
